(19) United States
(12) Patent Application Publication
(10) Pub. No.: US 2012/0198487 A1
(43) Pub. Date: Aug. 2, 2012

(54) CONTENT RECOMMENDATION SYSTEM

(75) Inventors: Masato SUZUKI, Yokohama (JP); Kazushige HIROI, Machida (JP)

(73) Assignee: HITACHI CONSUMER ELECTRONICS CO., LTD., TOKYO (JP)

(21) Appl. No.: 13/346,952

(22) Filed: Jan. 10, 2012

(30) Foreign Application Priority Data
Jan. 31, 2011 (JP) 2011-017402

(51) Int. Cl. H04N 21/442; H04N 21/24

(52) U.S. Cl. 725/13; 725/9

(57) ABSTRACT

It is provided a content recommendation system comprising a unit of storing the related information of the content; a history with respect to the content; determination information indicating whether to validate processing of extracting the recommendation content, which uses the each piece of the related information; and an effective period from a last use date, in which the determination information indicates “valid”; a unit of extracting the last use date of the each piece of the related information from the operation history, and, the determination information of the each piece of the related information to indicate “invalid” if a number of days elapsed since the last use date exceeds the effective period; and a unit of extracting the recommendation content by using at least one of the each piece of the related information of the content having the determination information thereof set to indicate “valid” and the operation history.

### CLAIM OF PRIORITY

The present application claims priority from Japanese patent application JP 2011-17402 filed on Jan. 31, 2011, the content of which is hereby incorporated by reference into this application.

### BACKGROUND OF THE INVENTION

This invention relates to a content recommendation technology for extracting a recommendation content to be recommended to a user by using an operation history, such as operation or viewing performed by a user, and related information of a content.

Content search and content recommendation are among methods which allow a user to find an optimum content for viewing. In the search, the user finds a content in an active manner. In contrast, in the recommendation, the user finds a content in a passive manner. In the case of digital television (DTV) which has become available worldwide in recent years, providing contents via recommendation is considered to be a preferred way.

To give one example of the method of providing recommendation contents to the user, there is a method involving accumulating an operation history, such as viewing of broadcasting, scheduling of unattended recording of a program, recording, or reproduction, which has been performed in a system in the past, and related information of the video, and analyzing the user's preference based on the accumulated history and related information, thereby recommending future programs or recorded contents.

With this method, in a case where the user's preference is analyzed based on the operation history and the related information, in some cases, the user's preference cannot be uniquely determined.

For example, in a case where there has been no addition or update to an operation history belonging to a given genre for a given period of time, the following three reasons are conceivable:
(reason A) the genre does not match the user's preference any more;
(reason B) the genre and the program match the user's preference, but the user did not view the program by chance; and
(reason C) the genre matches the user's preference, but the program itself does not match the user's preference.

In order to analyze those reasons, further accumulation of histories is required.

However, simply accumulating more histories increases the amount of calculation for performing content recommendation, which then prevents speedy content recommendation.

A related technology is described in JP 2006-94018 A.

The technology of JP 2006-94018 A is for, in a recommendation method capable of determining an evaluation value of a keyword for each genre, enabling a user's interest period to be set for each genre. Specifically, weighting is performed so that the evaluation value (preference point) becomes smaller as the number of days elapsed since the viewing date to a current date becomes larger. In another case, an upper limit for the number of days since the last viewing date to the current date can be set for each genre, and in a case where the upper limit for the number of days has been reached, the history itself is deleted.

### SUMMARY OF THE INVENTION

However, according to JP 2006-94018 A, the past operation histories are rendered obsolete or deleted in accordance with the upper limit for the number of days. Accordingly, as in the above-mentioned case (reason B), in a case where the user has not viewed a given program for a while by chance, the content continues to be in a state of being unlikely to be recommended until the evaluation value of the recommendation content matching the user's preference increases to the degree that the content becomes likely to be recommended. In addition, in a case where the upper limit for the number of days has been reached and the corresponding history has been deleted, the corresponding content is never to be recommended.

It is an object of this invention to provide a content recommendation technology capable of, in a case where a content having (belonging to) particular related information (for example, genre) has not been used for a given period of time, realizing speedy content recommendation after the given period of time, and in a case where the content having (belonging to) the above-mentioned particular related information (for example, genre) is used after the given period of time, enabling content recommendation with respect to the content having the above-mentioned particular related information.

The representative one of inventions disclosed in this application is outlined as follows. There is provided a content recommendation system for extracting a recommendation content based on one of related information of a content and an operation history and recommending the recommendation content to be recommended to a user. The content recommendation system comprising: a unit of storing the related information of the content; a history with respect to the content; determination information indicating, for one of each piece of the related information and each operation history, whether or not to validate processing of extracting the recommendation content, which uses the each piece of the related information; and an effective period from a last use date, in which the determination information indicates “valid”; a unit of extracting the last use date of the each piece of the related information from the operation history, and, setting the determination information of the each piece of the related information to indicate “invalid” in a case where a number of days elapsed since the last use date exceeds the effective period; and a unit of extracting the recommendation content by using at least one of the each piece of the related information of the content having the determination information thereof set to indicate “valid” and the operation history.

With this configuration, not all the histories are used for the content recommendation, and hence load caused by calculation for the content recommendation is reduced, thereby enabling high-speed calculation. In addition, the histories are left undeleted and are not used simply for the content recommendation calculation, and hence the histories can be used again in accordance with the setting of the effective period or a usage condition thereafter. For example, assuming that the related information of a content is “genre” and the effective period is three months, in a case where a user has not viewed a program belonging to a genre “drama” for three months, contents having the genre “drama” as the related information cease to be recommended. However, after that, when the user views a program belonging to the genre “drama”, the last use date of the history having the genre “drama” as the related information is updated, which enables pieces of the related information from the past, such as start date information, start time information, and cast information, to be used for the content recommendation. Therefore, it is possible to perform such content recommendation that matches the user's preference.

According to this invention, in a case where a content has not been used for a given period of time, the content recommendation which matches the user's preference can be performed again by using the related information of the content. Further, during a period in which a content is not used, the related information thereof is not used for the content recommendation, and hence the amount of data to be subjected to the content recommendation calculation decreases, with the result that high-speed content recommendation is realized.

### BRIEF DESCRIPTION OF THE DRAWINGS

The present invention can be appreciated by the description which follows in conjunction with the following figures, wherein:

FIG. 1 is a block diagram showing an example of a content recommendation system according to an embodiment of this invention;

FIGS. 2A to 2C are explanatory diagrams each illustrating a related information table of the operation history according to the embodiment of this invention;

FIGS. 3A to 3C are explanatory diagrams each illustrating an effective period determination table according to the embodiment of this invention;

FIGS. 4A and 4B are explanatory diagrams each illustrating a content information table according to the embodiment of this invention;

FIGS. 5A to 5C are explanatory diagrams each illustrating a recommendation result table according to the embodiment of this invention;

FIGS. 6A and 6B are flowcharts each illustrating a content recommendation processing according to the embodiment of this invention; and

FIGS.7A to 7D are explanatory diagrams each illustrating an user interface (UI) according to the embodiment of this invention.

### DETAILED DESCRIPTION OF THE PREFERRED EMBODIMENTS

Hereinafter, embodiments of this invention are described with reference to the accompanying drawings. It should be noted, however, that this invention is not limited to the embodiments provided herein. Components denoted by the same numbers and symbols have similar functions.

Further, the term “operation history” as used herein includes the scheduling of unattended recording of a program, the scheduling of viewing of a program, operations for recording and reproduction, and a viewing history.

### First Embodiment

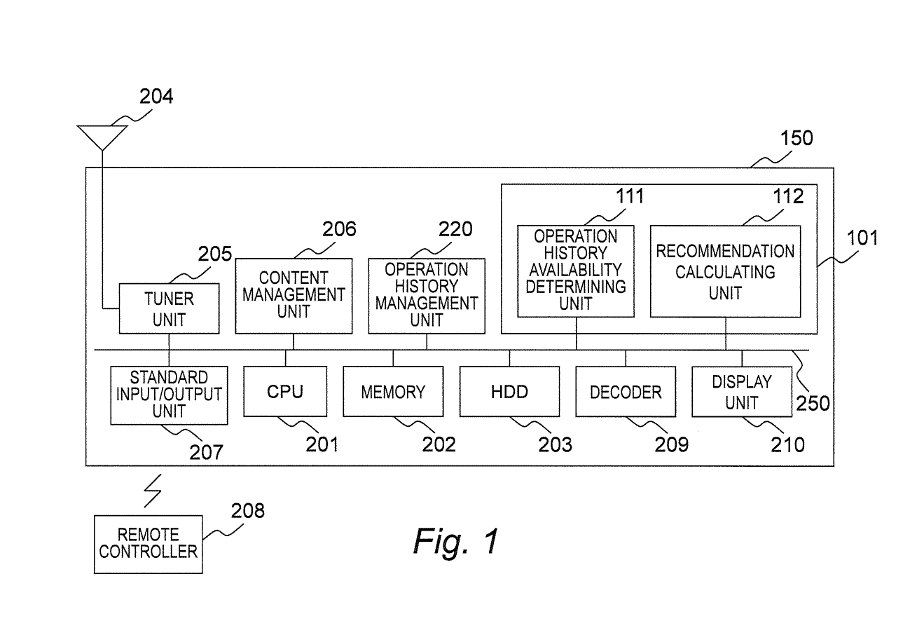

FIG. 1 shows an example of a content recommendation system according to a first embodiment of this invention. First, a configuration and functions thereof are described.

A content recommendation system 150 includes a central processing unit (CPU) 201, a memory 202, a hard disk drive (HDD) 203, an antenna unit 204, a tuner unit 205, a content management unit 206, a standard input/output unit 207, a remote controller 208, a decoder 209, a display unit 210, an operation history management unit 220, an operation history availability determining unit 111, and a recommendation calculating unit 112, which are coupled to one another by a bus 250. The content recommendation system 150 is realized by, for example, a digital television (DTV) set, an HDD recorder, or a personal computer (PC) capable of recording with a content recommendation function. Further, the operation history availability determining unit 111 and the recommendation calculating unit 112 constitute a calculation processing unit 101 for operation history availability determination.

The CPU 201, the memory 202, and the HDD 203 have a function of running an operating system (OS) and an application program of the content recommendation system 150. The kinds of the OS and the application program are not particularly limited. In a case where the content recommendation system 150 is a PC, an OS and an application program for the PC may be used. In a case where the content recommendation system 150 is a DTV set, an OS and an application program for the DTV set may be used, and in a case where the content recommendation system 150 is an HDD recorder, an OS and an application program for the HDD recorder may be used. Further, the DTV set or the HDD recorder capable of recording broadcasts can record contents on the HDD 203. Further, it is possible to accumulate information on programs scheduled to be broadcast by a received broadcast wave, content information on recorded programs, and operation histories.

The antenna unit 204 is an antenna connector for receiving the broadcast wave, and couples to signal lines for terrestrial broadcasting, BS broadcasting, and the like.

The tuner unit 205 has a function of extracting, from the broadcast wave received by the antenna unit 204, a stream obtained by multiplexing video and audio of channels to be selected and service information (SI) such as an electronic program guide (EPG).

The content management unit 206 is capable of acquiring the EPG from the stream extracted at the tuner unit 205, storing the EPG in the HDD 203, and, in a case where required by other functions, outputting the required EPG information. Further, the content management unit 206 has a function of acquiring and managing program information of contents recorded on the HDD 203, and manages all pieces of content information in the system, such as information on the broadcast wave and recorded programs.

The standard input/output unit 207 has a function of receiving an operation made by a user. For example, in a case where the content recommendation system 150 is a DTV set or an HDD recorder, the function is for receiving an input from a remote controller, and in a case where the content recommendation system 150 is a PC, the function is for receiving an input from a keyboard or a mouse.

The remote controller 208 has a function with which the user operates the content recommendation system 150, and is capable of such operations as menu display, content list display, channel selection, and content reproduction.

The decoder 209 has a function of decoding the stream extracted at the tuner unit 205 and stream video and audio recorded on the HDD 203.

The display unit 210 has a function of outputting video and audio decoded by the decoder 209, and a function of displaying a system-specific menu, a content list, and the like.

The above-mentioned components 201 to 210 constitute a functional group for causing the content recommendation system 150 to operate as a DTV set, an HDD recorder, or a PC, and this invention is not limited to this configuration as long as reception, recording, and reproduction of broadcasts, management of the content information of broadcasts and recorded programs, and external operation are possible.

The operation history management unit 220 has a function of managing, in the content recommendation system 150, an operation history, a last use date of the operation history, and related information (such as genre, title, cast) of the corresponding content, and a function of outputting the operation history and the related information to the other functional blocks. Specifically, in the case where the content recommendation system 150 is a recordable DTV set, for example, in a case where an operation history which involves a user's intentional operation, such as the scheduling of unattended recording of a program or the reproduction of a recorded content, has been generated, the content recommendation system 150 manages the operation history and the related information regarding the content, such as a program genre, in association with each other. As for the operation details, this invention is not limited to the operation details described above, and all operations relating to the content may be treated as storage targets. Further, the operation history may be retained for a longer period than an effective period described later. Under conditions such as those occurring in a case where an arbitrary number of days has been exceeded, a case where a storage area allocated for the operation history in the HDD 203 has become full, and a case where a predetermined period has elapsed, the operation history is deleted by a predetermined method, such as in chronological order of update time of the operation history or in chronological order of broadcast date of a program of the operation history.

The operation history availability determining unit 111 has a function of acquiring the operation history from the operation history management unit 220, determining a differential number of days between the last use date of the operation history and a current date (the number of days elapsed since the last use date), and generating and managing the operation history added with a deter urination on availability, which is obtained by adding to the operation history, as an availability determination result, a determination on whether the differential number of days does not exceed the effective period (valid: o) or exceeds the effective period (invalid: x), and a function of generating and managing availability indicating information which indicates, based on the availability determination result, whether the available period has not expired (valid: o) or has expired (invalid: x) for each piece of the related information.

The recommendation calculating unit 112 has a function of acquiring the operation history added with a determination on availability by the operation history availability determining unit 111 and the availability indicating information, and performing recommendation calculation through which future programs or recorded contents are recommended by using only available operation histories, or a function of recommending only available contents.

Further, the recommendation calculating unit 112 may have a function of performing the recommendation calculation through which future programs or recorded contents are recommended by using only the related information having an available operation history or by using only an available operation history and the related information having an available operation history, or a function of recommending only an available content.

Further, the recommendation calculating unit 112 may have a function of performing the recommendation calculation through which future programs or recorded contents are recommended by using all operation histories, and excluding a content having such a value in the related information that indicates that the available period has expired from the recommended content candidates by using the availability indicating information generated by the operation history availability determining unit 111. In other words, only a content whose availability indicating info i nation indicates “valid” may be extracted.

Further, the recommendation calculating unit 112 has a function of performing the recommendation calculation through which future programs or recorded contents are recommended by using all operation histories, and excluding a content having such a value in the related information that indicates that the available period has expired from the recommended content candidates by using the availability indicating information generated by the operation history availability determining unit 111, but, under a given particular exceptional condition, canceling the exclusion.

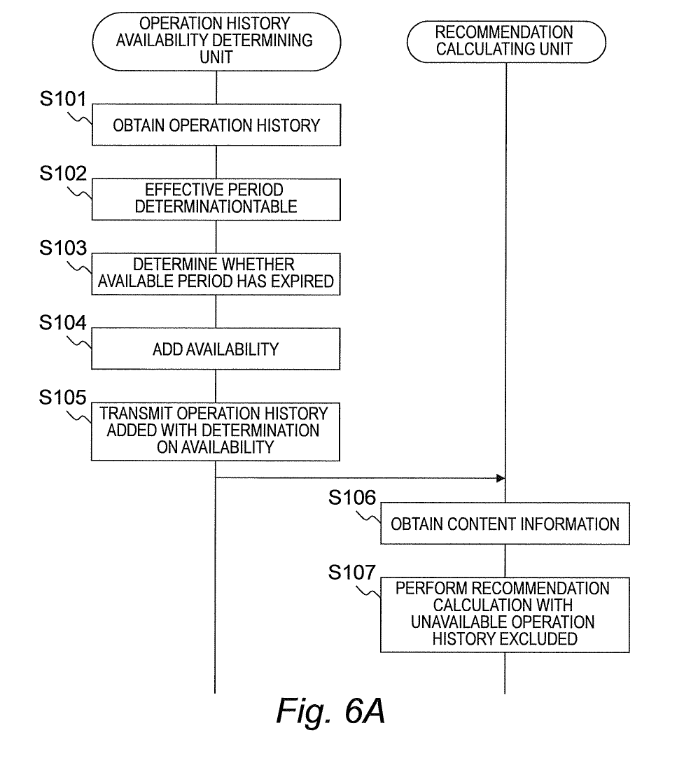

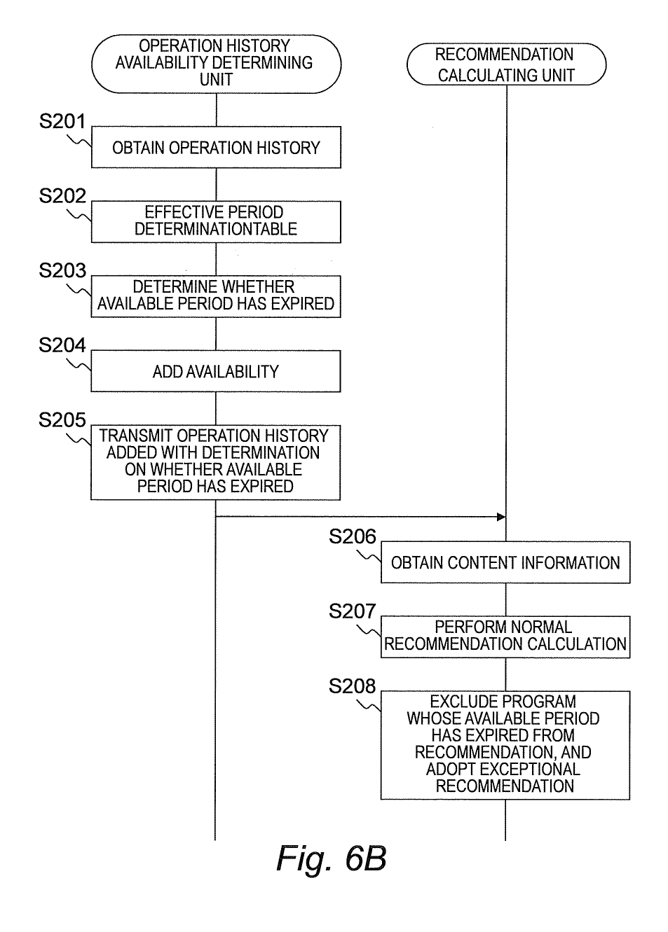

With the configuration of FIG. 1, the content recommendation system 150 generates a recommendation content by following a flow illustrated in FIG. 6A. First, the processing flow of FIG. 6A is described. In this embodiment, the value of the related information, which is subjected to the operation history availability determination, is “genre”.

FIG. 6A illustrates the processing flow required for the calculation processing unit 101 for operation history availability determination to perform the content recommendation calculation by using only available operation histories among the operation histories added with a determination on availability.

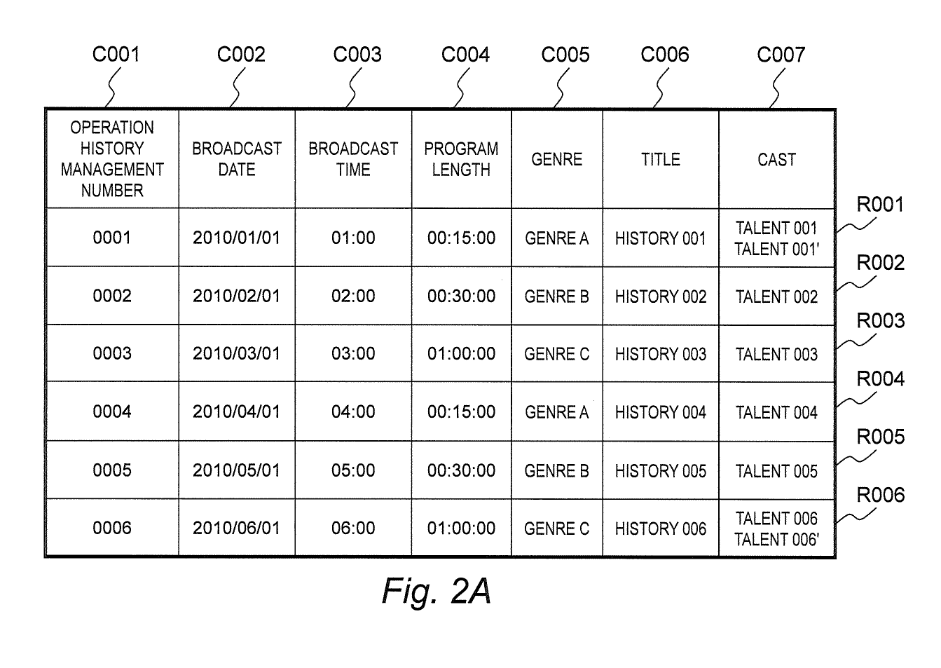

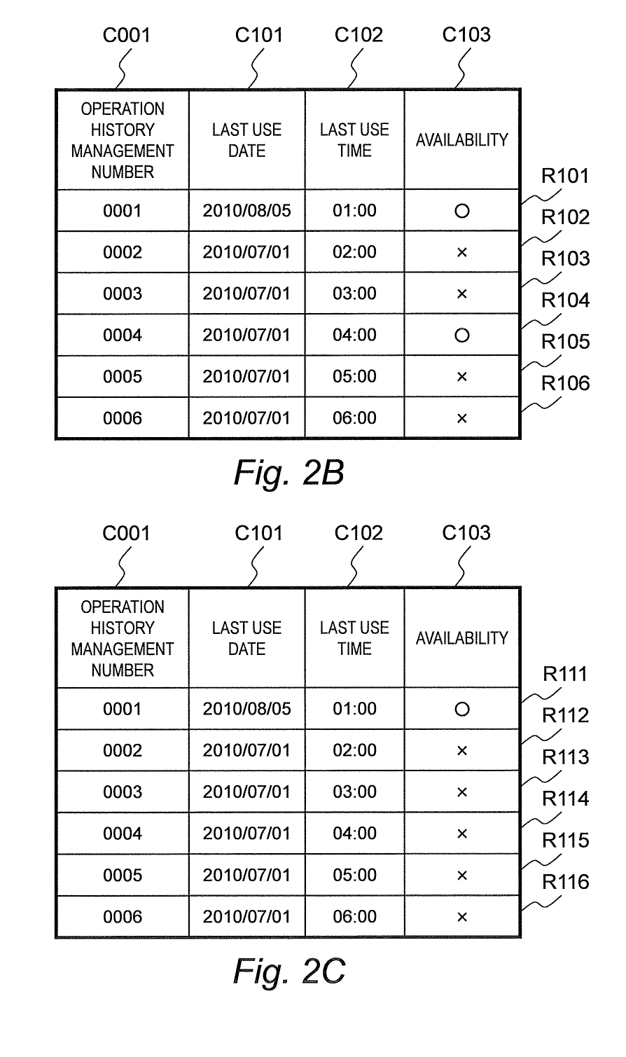

In S101, the operation history availability deter mining unit 111 acquires operation histories from the operation history management unit 220 as illustrated in FIGS. 2A, 2B, and 2C. The operation history is configured by a related information table and a last use date management table. FIG. 2A illustrates the related information table of the operation history, and the related information table of the operation history includes an operation history management number C001 for uniquely identifying the operation history, and a broadcast date C002, a broadcast time C003, a program length C004, a genre C005, a title C006, and a cast C007, which are pieces of the related information of a content. Currently, six records of R001 to R006 are recorded. On the other hand, FIG. 2B illustrates a management table for managing the last use date of each operation history. This management table includes a last use date C101 on which the content was used last, a last use time C102, and availability C103 indicating whether or not the operation history is to be used for recommendation, and six records R101 to R106 are currently recorded. At this stage, each value of the availability C103 is not set.

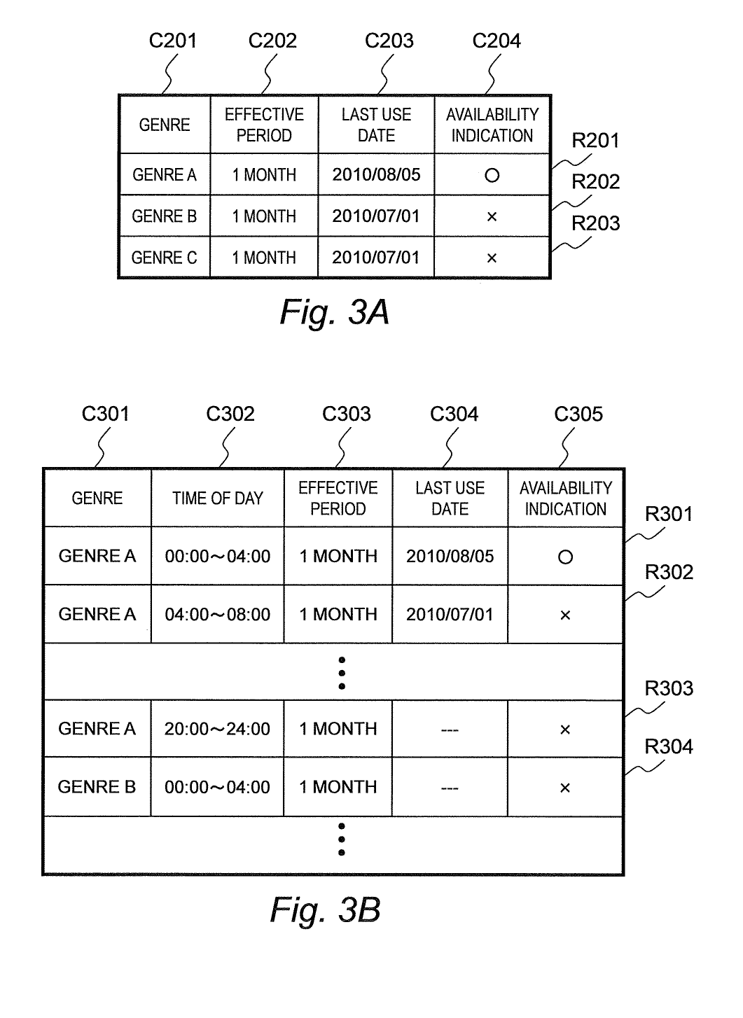

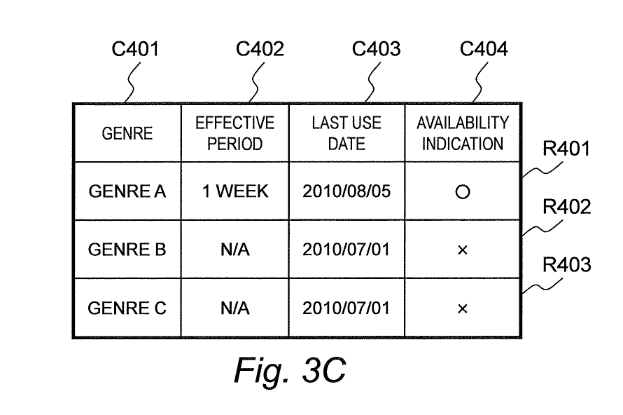

Next, in S102, the operation history availability determining unit 111 includes an effective period determination table illustrated in FIG. 3A. FIG. 3A illustrates the effective period determination table for each value of the genre of the related information, and the effective period determination table includes a genre C201, an effective period C202 represented by the number of days from the last use date C101, in which the content recommendation calculation is performed by using the related information of the genre, a last use date C203 on which the content was used last, and an availability indication C204 indicating whether or not the related information of the corresponding genre is to be used for the recommendation calculation. The effective period C202 is set to a fixed value. At this stage, each value of the last use date C203 and the availability indication C204 is not set.

Next, in S103, in a case where the genre C201 of each of records R201 to R203 of FIG. 3A coincides with the genre C005 of each of the records R001 to R006 of FIG. 2A, the operation history availability determining unit 111 writes the latest date in the last use date C101 in a corresponding entry of the last use date C203.

Subsequently, the operation history availability determining unit 111 determines whether or not the number of days elapsed since the last use date C203 exceeds the effective period C202. in a case where the number of days elapsed exceeds the effective period C202, a mark “X” indicating “invalid” is written in the availability indication C204, and in a case where the number of days elapsed does not exceed the effective period C202, a mark “o” indicating “valid” is written in the availability indication C204. In this embodiment, assuming that the current date is “2010/08/06”, the genre for which the effective period has not expired is a genre A alone. Hence, the mark “o” indicating “valid” is written in a cell being an intersection of the availability indication C204 and the record R201.

Subsequently, in S 104, in accordance with the validity in the availability indication C204, the operation history availability determining unit 111 determines, for the availability C103, whether or not the related information of a content belonging to the genre C005 which coincides with the genre C201 is available, and writes a result in the availability C103. Only the genre A is selected in S 103, and hence only the operation histories of contents belonging to the genre A are considered available.

Subsequently, in S 105, the operation history availability determining unit 111 transmits the related information table of FIG. 2A and the management table of FIG. 2B to the recommendation calculating unit 112.

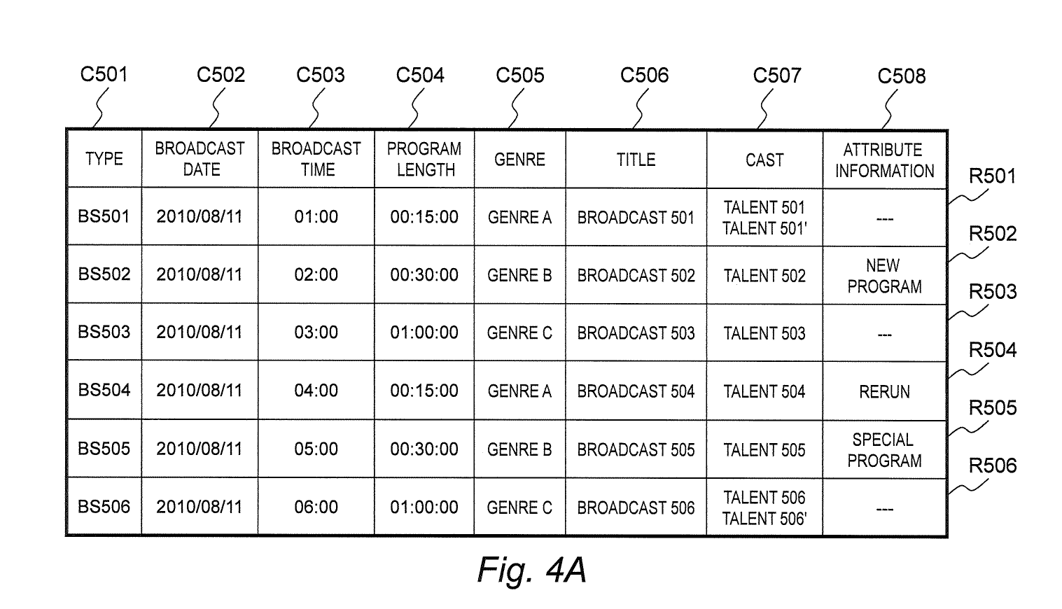

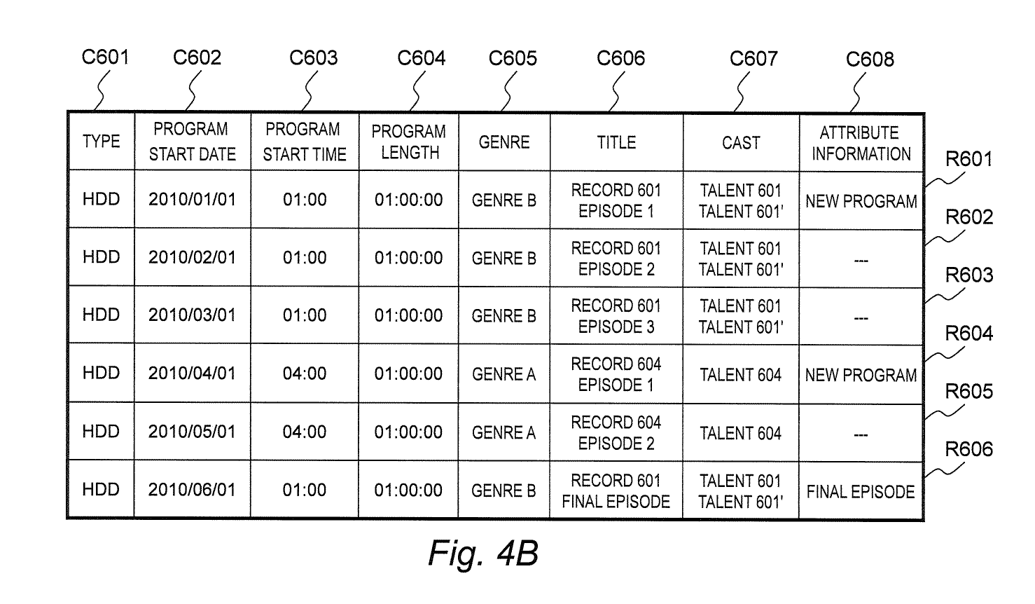

Subsequently, in S 106, the recommendation calculating unit 112 acquires the content information for performing the recommendation calculation. The content information is expressed by tables as in FIGS. 4A and 4B. The table of FIG. 4A includes a column C501 indicating the broadcast wave or the recorded content and a broadcast date C502, a broadcast time C503, a program length C504, a genre C505, a title C506, a cast C507, and attribute information C508, which are pieces of the related information of the content.

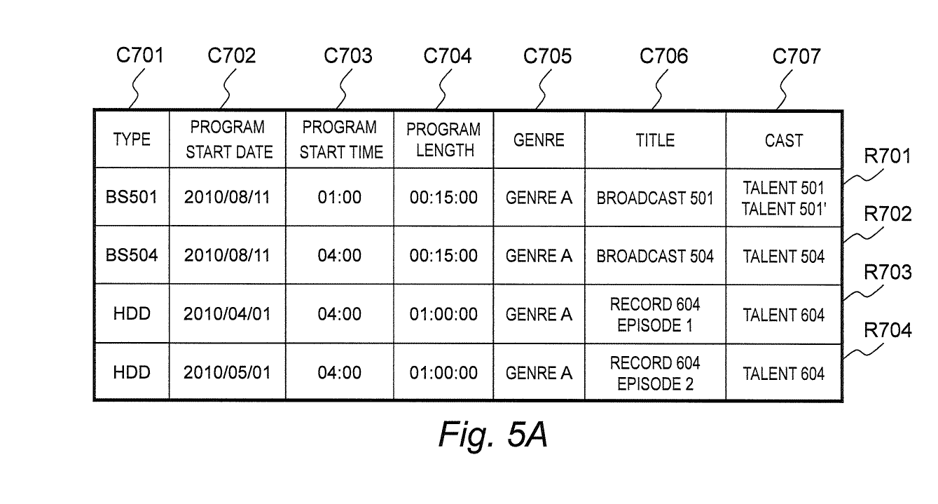

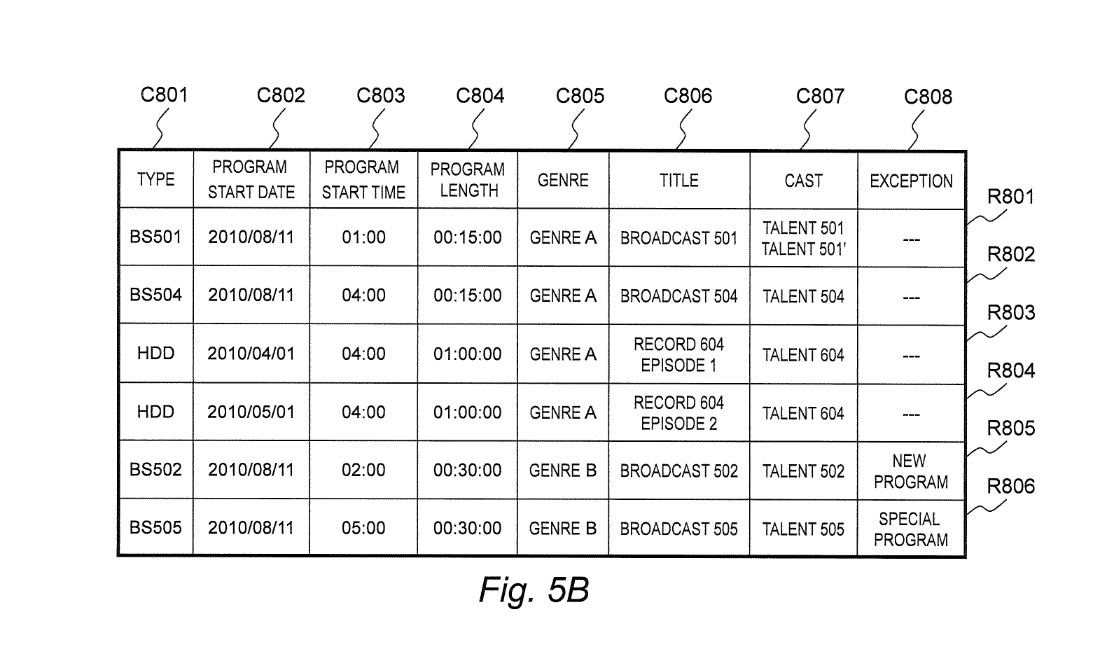

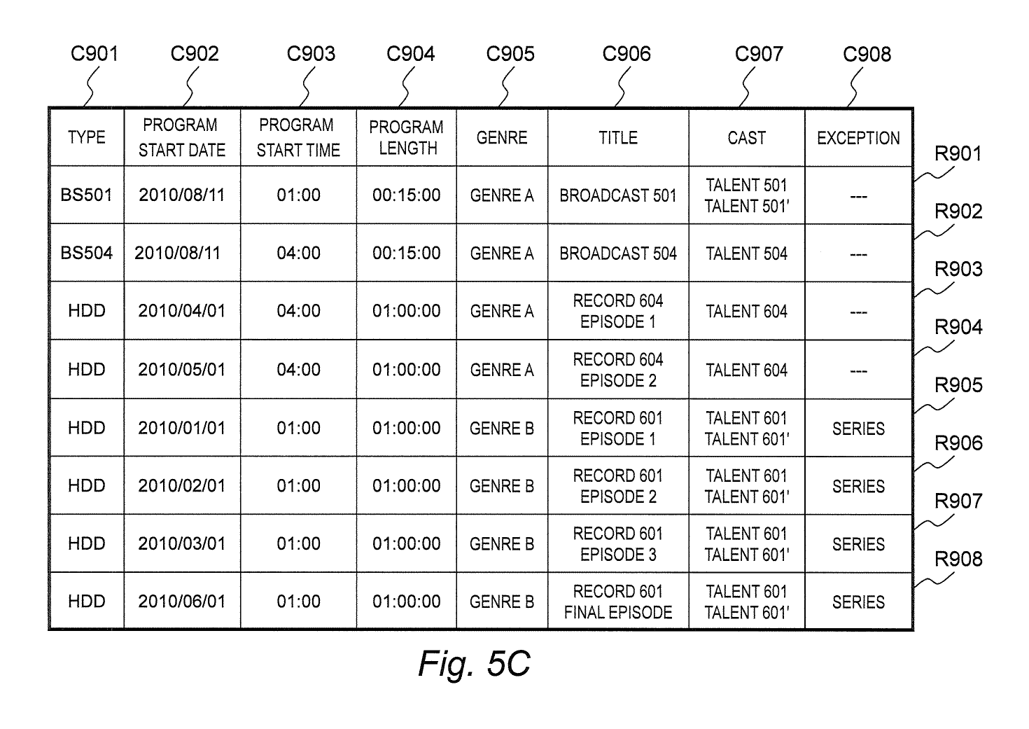

Subsequently, in S 107, the recommendation calculating unit 112 performs the recommendation calculation by using FIGS. 4A and 4B and FIGS. 2A and 2B. In the recommendation calculation, the recommendation calculating unit 112 performs the recommendation calculation by using only operation histories whose availability C103 indicates “valid”. For the sake of convenience, in this embodiment, as a result of performing the recommendation calculation based on all the operation histories, all the contents of FIGS. 4A and 4B are output as recommendation results. Further, in a case where the genre C005 of the operation history and the genre C505 of the content information do not coincide with each other, no weight is placed in the recommendation, and hence, in the case of a different genre, the content is not output as the recommendation result. Under such conditions, the recommendation result is represented by a table as in FIG. 5A. An entry of the genre C201 whose availability indication C204 indicates “valid” is the genre A, and based thereon, the availability C103 is determined. Therefore, only the contents belonging to the genre A are recommended in the recommendation result.

As described above, by temporarily invalidating the operation histories of the genres which have not been used for a given period of time from the recommendation calculation, it is possible to reflect the user's recent genre preference. Further, in a case where an operation history belonging to the genre which has not been used for a given period of time is newly added, it is possible to validate the past operation histories belonging to the same genre. Accordingly, even for such genre, it is possible to perform recommendation with higher accuracy.

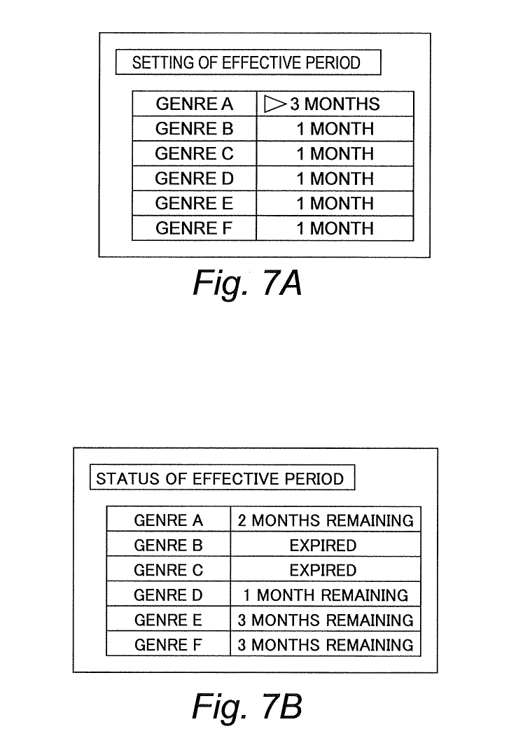

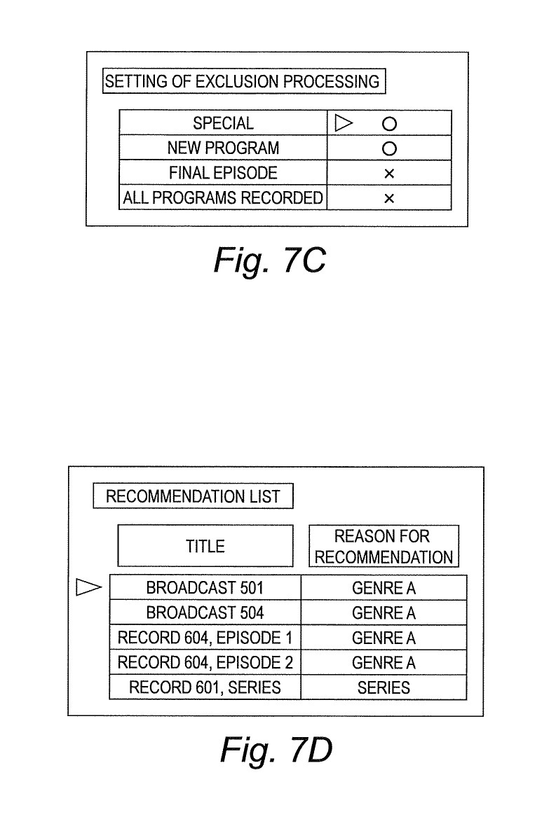

Further, with regard to the effective period, user interface (UI) display illustrated in FIGS. 7A and 7B allows the user to set the effective period and also allows the presentation of the status of the effective period to the user. FIG. 7A illustrates the UI display for setting the effective period, and by setting a value in this UI display, it is also possible to reflect the value to the effective period C202 of the effective period determination table of FIG. 3A. Further, FIG. 7B illustrates the UI display presenting the current status of the effective period, and is an example in which a value obtained by subtracting the effective period C202 from a difference value between the last use date C203 of FIG. 3A and the current date is displayed. With the above-mentioned configuration, the user can set the effective period while recognizing the status of the effective period, with the result that the recommendation calculation using the effective period can be performed flexibly.

### Second Embodiment

In the first embodiment, the effective period and the availability of FIG. 2B and FIG. 3A are applied only to the genre. However, in this embodiment, based on FIG. 2C and FIG. 3B, the validity can be set by additionally considering the time of day of each genre.

FIG. 3B is described. A difference between FIG. 3B and FIG. 3A is the addition of a time of day C302. In this case, the effective period can be set for each of different times of day even in the same genre.

In this case, when the operation histories of FIG. 2A are used, values indicated in the column of an availability indication C305 are obtained in

S103. In this embodiment, only a record R301 has the availability indication C305 indicating “valid”, and records R302 and R303 have the availability indication C305 indicating “invalid”. Accordingly, even in the same genre, it is possible to distinguish between “valid” and “invalid” in accordance with the time of day.

As described above, by temporarily invalidating the operation histories having a combination of the genre and the time of day which have not been used for a given period of time from the recommendation calculation, it is possible, even in the same genre, to invalidate an operation history having the time of day for which the user has no interest any more. Further, similarly to the first embodiment, in a case where an addition has been made to the operation history having the invalidated combination of the genre and the time of day, that operation history is validated again, with the result that the past operation history can be utilized.

In this embodiment, there has been given an example in which the time of day is used in addition to the genre. However, it is also possible, as another example, to use a combination of the genre and the cast or such other combination. In other words, the respective values of the related information may be used singly or in combination.

### Third Embodiment

In the first embodiment, the effective period C202 of FIG. 3A is fixed, but a third embodiment is different from the first embodiment in that the value of the effective period C202 is variable. Referring to the related information table of FIG. 2A, the management table of FIG. 2C, and the effective period determination table of FIG. 3A according to the first embodiment, in a case where the effective period has expired as in the records R202 and R203, the effective period is invalidated as in records R402 and R403 of the effective period determination table of FIG. 3C. On the other hand, assuming that the previous last use date of a record R111 is “2010/07/01”, the effective period of a record R401 is invalidated similarly as in the case of the records R402 and R403 until a time point of “2010/08/04”. Then, in a case where the last use date of the record R111 is newly updated to “2010/08/05”, the effective period of the record R401 is changed to, for example, one week. After that, in a case where the operation history belonging to the same genre is further updated within the period in the same manner, the effective period may be increased to two weeks, and further to three weeks. Further, in the case of increasing the effective period, a maximum value of the effective period may be set.

As described above, by making the effective period variable, in a case where the user has unintentionally viewed a program belonging to the genre in which the user has no interest any more, it is possible to invalidate that genre again in a short effective period.

### Fourth Embodiment

This embodiment is different from the first embodiment in a method for the recommendation calculation using the tables of FIGS. 2A, 2B, 3A, 4A, and 4B.

With the configuration of FIG. 1, the content recommendation system 150 generates a recommendation content by following a flow illustrated in FIG. 6B. First, the processing flow of FIG. 6B is described. S201 to S204 and S206 of FIG. 6B are the same as S101 to S104 and S106 of FIG. 6A.

Subsequently, in S105, the operation history availability determining unit 111 transmits the related information table of FIG. 2A and the management table of FIG. 2B as well as the effective period determination table of FIG. 3A to the recommendation calculating unit 112.

Subsequently, in S207, the recommendation calculating unit 112 performs the recommendation calculation by using all the operation histories. All the contents in the content information tables of FIGS. 4A and 4B are output as candidates for the recommendation result. Then, in accordance with the available period of each entry of the genre C201 in the effective period determination table of FIG. 3A, the recommendation calculating unit 112 excludes, from the candidates for the recommendation result, recommendation candidates belonging to the corresponding genre. Further, while excluding such candidates in this manner, it is also possible to prevent such contents that have special program attribute information such as “new program” or “special program” from being excluded from the recommendation program candidates. Further, in the same manner, it is also possible to prevent recommendation program candidates whose episodes are recorded from the first episode to the final episode from being excluded. FIGS. 5B and 5C illustrate recommendation results obtained after performing exclusion processing in the above-mentioned manner. FIG. 5B illustrates a recommendation result table obtained by preventing the “new program” and the “special program” from being excluded. Records R801 to R804 represent contents belonging to the genre A selected based on the effective period table of FIG. 3A. A record R805 represents a content which does not belong to the genre A but is a new program, and a record R806 represents a content which does not belong to the genre A, either, but is a special program. Meanwhile, FIG. 5C illustrates a recommendation result table obtained by preventing contents which are recorded from the first episode to the final episode from being excluded. Records R901 to R904 represent contents belonging to the genre A selected based on the effective period table of FIG. 3A, and records R905 to R908 represent contents which do not belong to the genre A but are recorded from the first episode to the final episode.

With the above-mentioned configuration, by excluding or canceling the exclusion of contents from candidates for the recommendation result, it is possible to recommend a program belonging to the genre in which the user has interest, and even for the genre in which the user may have lost his/her interest, it is possible to recommend programs and contents which may attract the user's interest.

Further, in this embodiment, UI display illustrated in FIGS. 7C and 7D may be performed. FIG. 7C illustrates a UI which allows the user to select a program attribute for which the exclusion is to be canceled. In accordance with the validity setting made in this UI, it is possible to perform processing of canceling the exclusion. Further, FIG. 7D illustrates UI display for displaying a recommendation list. At the time of displaying the recommendation list, it is possible to describe reasons for the recommendation for the respective titles, and it is also possible to present details corresponding to entries of exceptions C808 and C908.

With the above-mentioned configuration, for the recommendation result of programs and contents which are likely to attract the user's interest, it is possible to display a setting interface and reasons for recommendation in such a manner that does not make the user feel unsatisfaction.

While the present invention has been described in detail and pictorially in the accompanying drawings, the present invention is not limited to such detail but covers various obvious modifications and equivalent arrangements, which fall within the purview of the appended claims.

What is claimed is:

1. A content recommendation system for extracting a recommendation content based on one of related information of a content and an operation history and recommending the recommendation content to be recommended to a user,
the content recommendation system comprising:
a unit of storing the related information of the content; a history with respect to the content; determination information indicating, for one of each piece of the related information and each operation history, whether or not to validate processing of extracting the recommendation content, which uses the each piece of the related information; and an effective period from a last use date, in which the determination information indicates “valid”;
a unit of extracting the last use date of the each piece of the related information from the operation history, and, setting the determination information of the each piece of the related information to indicate “invalid” in a case where a number of days elapsed since the last use date exceeds the effective period; and
a unit of extracting the recommendation content by using at least one of the each piece of the related information of the content having the determination information thereof set to indicate “valid” and the operation history.

2. The content recommendation system according to claim 1, further comprising a unit of changing the determination information from “invalid” to “valid” in a case where the last use date of the operation history for which the determination information is set to indicate “invalid” is updated.

3. The content recommendation system according to claim 1, further comprising a unit to which the user sets the effective period.

4. The content recommendation system according to claim 1, wherein the effective period is set for each time of day.

5. The content recommendation system according to claim 1, wherein the related information for which the effective period is set includes a genre of the content.

6. The content recommendation system according to claim 1, further comprising a unit of keeping the determination information of the each piece of the related information set to indicate “valid” in a case where the number of days elapsed since the last use date exceeds the effective period.

7. The content recommendation system according to claim 1, further comprising a unit of deleting a history having the determination information thereof set to indicate “invalid” after a lapse of a predetermined period of time.

8. The content recommendation system according to claim 7, further comprising a unit of changing the determination information to indicate “valid” in a case where the last use date is updated before the lapse of the predetermined period of time.

9. A content recommendation system for extracting a recommendation content based on one of related information of a content and an operation history and recommending the recommendation content to be recommended to a user,
the content recommendation system comprising:
a unit of storing the related information of the content; a history with respect to the content; determination information indicating, for one of each piece of the related information and each operation history, whether or not to validate processing of extracting the recommendation content, which uses the each piece of the related information; and an effective period from a last use date, in which the determination information indicates “valid”;
a unit of extracting the last use date of the each piece of the related information from the operation history, and, setting the determination information of the each piece of the related information to indicate “invalid” in a case where a number of days elapsed since the last use date exceeds the effective period; and
a unit of extracting the content having the determination information thereof set to indicate “valid” as the recommendation content.

10. The content recommendation system according to claim 9, further comprising a unit of changing the deter urination information from “invalid” to “valid” in a case where the last use date of the operation history for which the determination information is set to indicate “invalid” is updated,.

11. The content recommendation system according to claim 9, further comprising a unit to which the user sets the effective period.

12. The content recommendation system according to claim 9, wherein the effective period is set for each time of day.

13. The content recommendation system according to claim 9, wherein the related information for which the effective period is set includes a genre of the content.

14. The content recommendation system according to claim 9, further comprising a unit of keeping the determination information of the each piece of the related information set to indicate “valid” in a case where the number of days elapsed since the last use date exceeds the effective period.

15. The content recommendation system according to claim 9, further comprising a unit of deleting a history having the determination information thereof set to indicate “invalid” after a lapse of a predetermined period of time.

16. The content recommendation system according to claim 15, further comprising a unit of changing the determination information to indicate “valid” in a case where the last use date is updated before the lapse of the predetermined period of time.
